(19) United States
(12) Patent Application Publication
(10) Pub. No.: US 2010/0194180 A1
(43) Pub. Date: Aug. 5, 2010

(54) UNITIZED HUB AND RIM FOR OFF-ROAD VEHICLES

(75) Inventor: Ray Gibson, Jenks, OK (US)

Correspondence Address: CANTOR COLBURN, LLP, 20 Church Street, 22nd Floor, Hartford, CT, 06103, US

(73) Assignee: TEREX CORPORATION, Westport, CT (US)

(21) Appl. No.: 12/365,252

(22) Filed: Feb. 4, 2009

(51) Int. Cl. B60B 25/00; B60B 11/04; B62D 33/00

(52) U.S. Cl. 301/36.1; 280/6.15

(57) ABSTRACT

A hub for mounting a plurality of wheels of a vehicle, the hub including: an annular cylinder including at least two tire mounts disposed about a circumference of an outer surface of the cylinder, each of the mounts including at least one set of mounting features for receiving mounting hardware and retaining the tire. A dual wheel assembly and a vehicle are also disclosed.

### BACKGROUND OF THE INVENTION

1. Field of the Invention

The invention disclosed herein relates to land vehicles and, in particular, to dual wheels mounted on a unitized hub or rim.

2. Description of the Related Art

Large haulage trucks used for mining operations are often propelled using electric motorized wheel motors. The wheel motors are incorporated into a rear axle of the truck, with a wheel motor driving each dual wheel assembly. In conventional embodiments using wheel motor units, an electric traction motor is connected to a reduction gearcase, which, in turn, is fastened to a hub and, in turn, the dual wheel assembly, which includes tire and rim assemblies.

As one might imagine, dual wheel assemblies used in mining operations are subject to enormous amounts of wear and stress. Due to operational requirements for such assemblies, robust wheel assemblies are required. However, conventional dual wheel assemblies often prove to require more maintenance than desired, particularly when changing of at least one tire is needed.

As one example, in conventional dual wheel assemblies, wheel clamps, bolt circles and ring adapters and the associated fastener systems are a chronic source of maintenance and truck operational concern. Such components tend to lose torque (clamping force) due to rim re-seating during initial operation after maintenance. It is common to have to repeat the torquing process numerous times until there is no evidence of slippage of the rim on the hub. Clearly, taking such equipment out of service can cost a user a considerable amount, both in lost production and added maintenance expenses.

Over the years, various truck manufacturers have resorted to incorporating bolt-on rims which bolt directly onto the hub. Although the bolt-on rims solved the clamp issues, the bolted rims also require fastener torquing and sometimes re-torquing after initial operation. Torquing and re-torquing are labor intensive and costly.

Aside from the mechanical issues associated with conventional designs, tire maintenance and handling operations are very dangerous. This is due to a variety of factors, including weights involved and enormous supplies of pressurized air.

Therefore, what are needed are improved method and apparatus for mounting and dismounting large tires, such as those used for off-road operations. Preferably, the solutions provide users with limited exposure to safety hazards and expedite maintenance processes.

### BRIEF SUMMARY OF THE INVENTION

In one embodiment, the invention includes a hub for mounting at least one wheel of a vehicle, the hub including: an annular cylinder including at least one tire mount disposed about a circumference of an outer surface of the cylinder, each mount including at least one set of mounting features for receiving mounting hardware and retaining the tire.

In another embodiment, the invention includes a dual wheel assembly including: a unitized hub including an annular cylinder including an inner tire mount and an outer tire mount disposed about a circumference of an outer surface of the cylinder, each of the tire mounts separated by a mid-section; wherein the inner tire mount includes an inner set and an outer set of mounting features, and the outer tire mount includes an inner set and an outer set of mounting features; each of the inner sets and outer sets adapted for receiving mounting hardware and retaining an inner sidewall and an outer sidewall of a tire.

In a further embodiment, the invention includes a vehicle including: a rear axle including a dual wheel assembly disposed on each end thereof, each of the dual wheel assembly including a unitized hub including an annular cylinder including an inner tire mount and an outer tire mount disposed about a circumference of an outer surface of the cylinder, each of the tire mounts separated by a mid-section, wherein the inner tire mount includes an inner set and an outer set of mounting features, and the outer tire mount includes an inner set and an outer set of mounting features; each of the inner sets and outer sets adapted for receiving mounting hardware and retaining an inner sidewall and an outer sidewall of a tire; and a drive mechanism for propelling each of the dual wheel assemblies.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of an off-road vehicle including a dual wheel assembly;

FIG. 2 is a partial cross-sectional view of the dual-wheel assembly for incorporation into the vehicle of FIG. 1;

FIG. 3 provides another partial cross-sectional view of the dual-wheel assembly of FIG. 2;

FIG. 4 is a partial cross-sectional view of one set of mounting hardware;

FIG. 5 is a partial cross-sectional view of another embodiment of the dual-wheel assembly for incorporation into the vehicle of FIG. 1;

FIG. 6 provides a perspective view of an embodiment of the unitized hub for the dual wheel assembly; and

FIG. 7 is a flow chart depicting an exemplary method for assembling the dual-wheel assembly.

### DETAILED DESCRIPTION OF THE INVENTION

Disclosed are method and apparatus for mounting and dismounting large off-road tires. The invention provides for mounting of such tires onto a single hub, or a “unitized hub.” With the unitized hub, changing a tire no longer calls for first removing a wheel (that is, a rim with a tire mounted thereon) from a vehicle and then swapping the tire that is mounted on the rim. Rather, users are able to change the tire (or a plurality of tires) in place, without removing the unitized hub from the vehicle. By incorporating the unitized hub into a drive train for the vehicle, users avoid many maintenance and safety issues involved with the handling of tires mounted on rims.

Among other things, the invention provides a wheel assembly that includes at least one wheel. The wheel assembly offers cost savings, such as through simplified assembly processes, increased reliability, and reduced components. The wheel assembly may include one to many (a plurality of) tires. In some embodiments, and as generally discussed herein, the wheel assembly is realized as a dual-wheel assembly. However, it should be recognized that a dual-wheel assembly is not-limiting and merely an illustration of the teachings herein. An introduction to an exemplary vehicle making use of the wheel assembly is now provided.

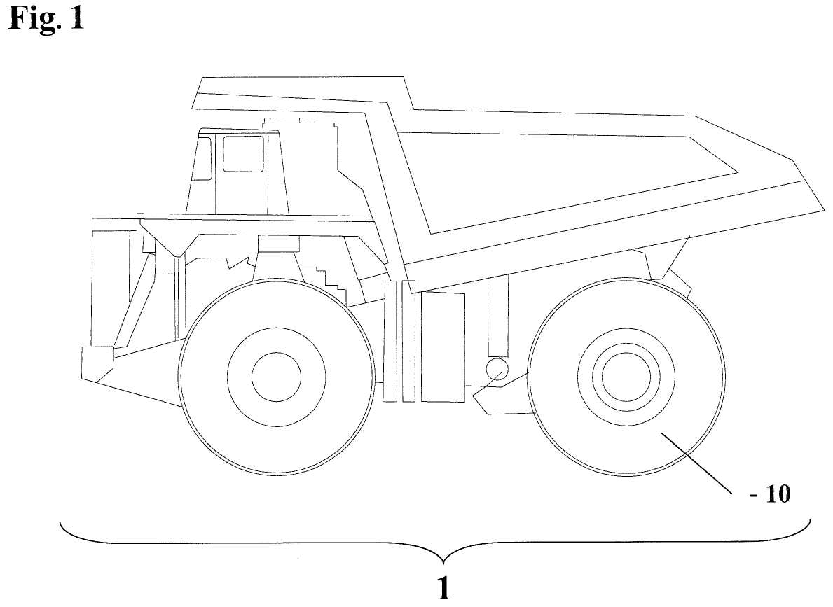

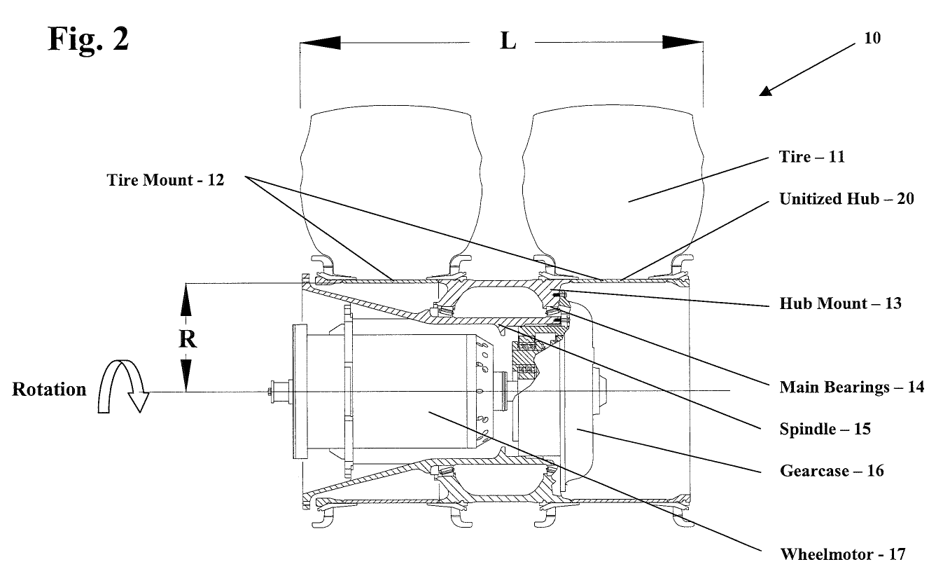

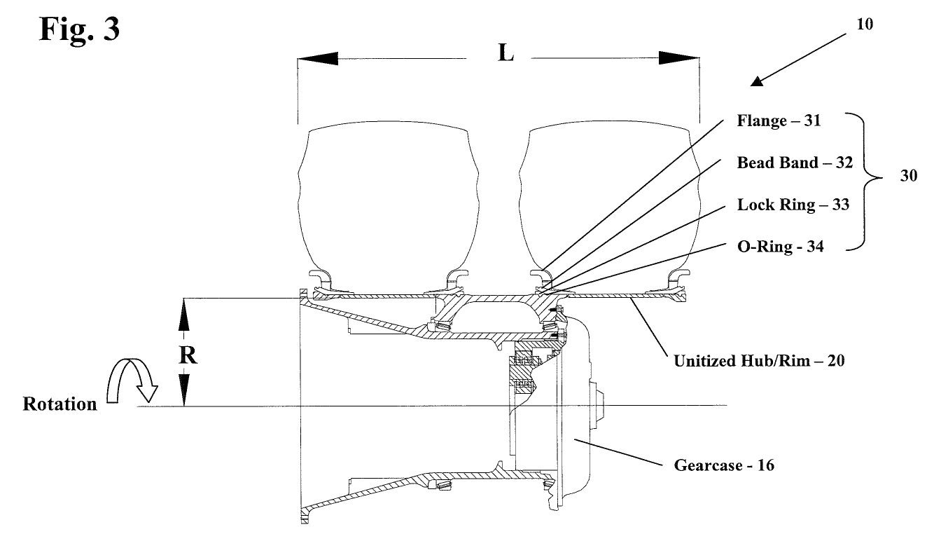

Referring to FIG. 1, there is shown an exemplary off-road vehicle 1. In this example, the off-road vehicle 1 includes a wheel assembly 10 for each side of a rear axle. In this embodiment, each wheel assembly 10 is a dual-wheel assembly. Each dual-wheel assembly 10 mounts to an electric wheel motor (shown in FIGS. 2 and 3), for providing propulsion to the off-road vehicle 1. Of course, the off-road vehicle 1 may be propelled by other apparatus, such as a conventional drive shaft (not shown). As such, the dual-wheel assembly 10 is not limited to use with the wheel motor, and illustration of the wheel motor merely is provided as an exemplary embodiment.

As one might surmise, the off-road vehicle 1 may include a variety of vehicles. Further, in some embodiments, such vehicles may be useful on a roadway, at least to some limited extent. Examples of vehicles that may make use of the dual-wheel assembly 10 include mining trucks, dump trucks, wheel loaders, scrapers, graders, diggers, dumpers, backhoes, handlers and the like. Accordingly, other vehicles, such as those traditionally used “on-road” may make use of the teachings herein.

Referring now to FIG. 2, there is shown a partial cross-sectional view of an embodiment of the wheel assembly 10. In this embodiment, the wheel assembly 10, shown as the dual-wheel assembly 10, is depicted in relation to some other components of the off-road vehicle 1. A unitized hub/rim 20 (i.e., a unitary combination of a conventional hub and rim) is shown. In some embodiments, the unitized hub/rim 20 (also referred to simply as the “unitized hub 20” or just the “hub 20”), generally forms an annular cylinder. A length, L, of the unitized hub 20 generally affords a desired separation between tires 11, when the tires 11 are properly mounted and inflated. Integrated into the unitized hub 20 are two separate tire mounts 12 for mounting each of the tires 11. The unitized hub 20 is of an appropriate radius, R, for being disposed concentric to and in mechanical engagement with a given embodiment of a drive mechanism. In this example, the drive mechanism includes a wheel motor 17 which provides mechanical energy through a spindle 15 and gear case 16. As may be noted, bearings 14 are generally included for ensuring alignment and smooth operation between the gear case 16 and the unitized hub 20. In this embodiment, the unitized hub 20 is mounted to the spindle 15 by use of a hub mount 13. Of course, 13, in other embodiments, the hub mount 13 may be adapted for fitting the particular type of drive, such as a drive shaft (not shown). The hub mount 13 may include installation features for securing the unitized hub 20 to a particular drive.

Each of the tire mounts 12 may accommodate additional components for mounting of a respective tire 11. Aspects of some of the additional components are depicted in FIG. 3.

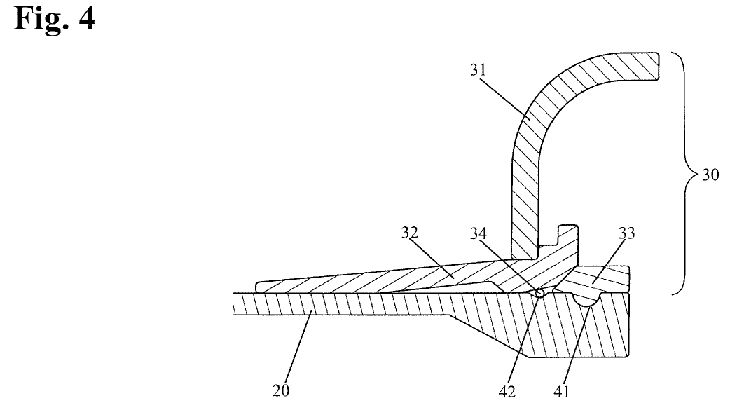

Referring now to FIG. 3 in greater detail, additional components for mounting of each respective tire 11 are provided as mounting hardware 30. In the embodiment illustrated, the mounting hardware 30 is a set that includes a flange 31, a bead band 32, a lock ring 33 and an O-ring 34. Two sets of mounting hardware 30 are used for mounting of each tire 11, one set for securing each sidewall of the tire 11. A close-up cross sectional view of the mounting hardware 30 is provided in FIG. 4.

Referring now to FIG. 4, in an exemplary cross-sectional view, one set of the mounting hardware 30 is shown. Embodiments of appropriate mounting hardware 30 are known in the art. For example, reference may be had to U.S. Pat. No. 6,568,764, issued May 27, 2003 to McNeil et al., entitled “Dual Wheel Assembly,” applicable portions of which are incorporated herein.

In the example provided in FIG. 4, the bead band 32 is mounted to an outer end of the unitized hub 20. The bead band 32 is a generally cylindrical or ring-like member of tapered thickness which provides a seat for a bead of the tire 11. The O-ring 34 is located in a shallow annular groove 42 on the unitized hub 20 to seal between the bead band 32 and the hub 20. The flange 31 is mounted on the bead band 32 to retain and support a side wall of the tire 11.

The bead band 32 is retained in position by the lock ring 33. In some embodiments, the lock ring 33 is a split lock ring 33. Generally, the lock ring 33 has an inner bead for being disposed into a deep annular groove 41 around the unitized hub 20. In some embodiments, the lock ring 33 is a ring that spans a circumference of about 360 degrees and includes a single break. Accordingly, the lock ring 33 may be spread for mounting. Once mounted, the lock ring 33 will generally snap back into an original form (due in part to materials, such as spring steel, used to form the lock ring 33). Accordingly, retainers, such as a bridge that may be bolted to each end of the “C” shape formed by the lock ring 33, may be used to keep the lock ring 33 in place.

The unitized hub 20 may vary in thickness as appropriate. For example, the unitized hub 20 may be thicker below the grooves 41, 42. Added thickness may be provided for various purposes, such as to improve strength of the hub 20, room for the grooves 41, 42 and the like. Thinner sections of the unitized hub 20 may be included, such as in an area opposite to the volume of the tire 11 between the sidewalls. Reduced thickness sections may be provided for various reasons such as to provide for lighter weight unitized hubs 20, to reduce manufacturing cost, and the like.

The mounting hardware 30 may be of a variety of embodiments, the example of FIG. 4 being merely one embodiment. Other embodiments, including those known in the art, may be used. In one embodiment, an inward most portion of an inward tire mount 12 may include features formed into the unitized hub 20, such as a permanent flange. In other embodiments, the inward most portion of the inward tire mount 12 makes use of the mounting hardware 30. The mounting hardware 30 may include other features such as interlocks, bolts, clamps, clips and the like.

The unitized hub 20 may include additional features and/or components on at least one of the outer surface and the inner surface. As one example, the hub 20 may be slightly depressed or dished on the outer surface and between tire mount 12 sections of the hub 20. In these embodiments, the slight depressions reduce friction between the tire 11 and the hub 20, thereby facilitating removal or installation of the tire 11.

The inner surface of the unitized hub 20 generally includes features for supporting the tire mounts 12, the mounting hardware 30 and other features on the outer surface, as well as installation features as a part of the hub mount 13 for mating the hub 20 with a drive of the off-road vehicle 1.

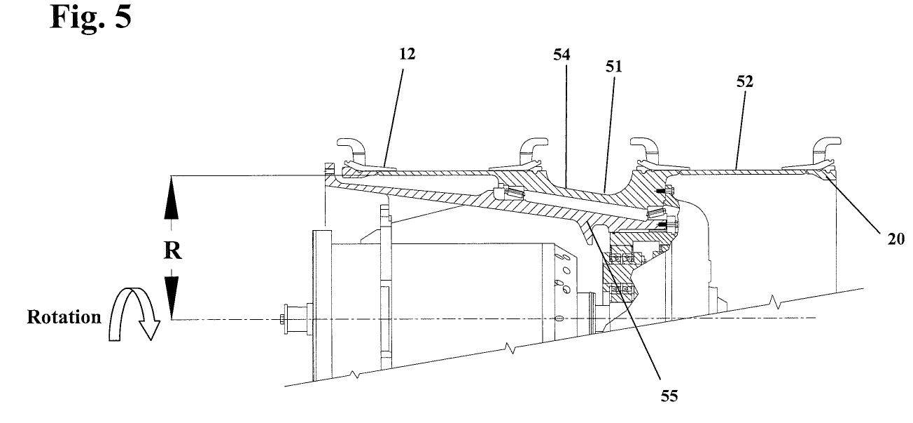

Referring now to FIG. 5, aspects of another embodiment of the unitized hub 20 are shown. In this example, the hub 20 includes a body having a taper 51 in a mid-section 54. The taper 51 is designed to accommodate mounting of the hub 20 onto a tapered spindle 55. However, in this embodiment, the hub 20 includes an elevated mount 52, such that the inner mount 12 and the elevated mount 52 are of about the same radius, R. Of course, the hub 20 includes design features (not shown) required for support of loading upon the tires 11.

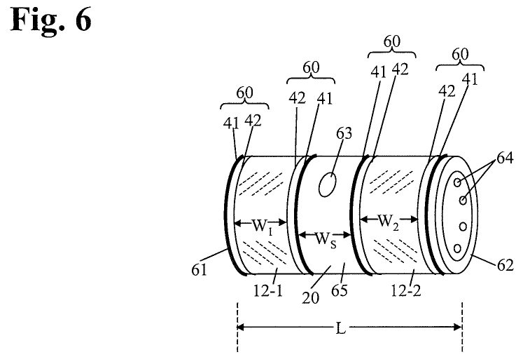

Referring now to FIG. 6, a perspective diagram of the unitized hub 20 is provided. In this embodiment, the unitized hub 20 is generally of a length, L. For purposes of discussion, the unitized hub 20 originates at an inner end 61, and terminates at an outer end 62. The outer surface of the hub 20 generally includes a plurality of features 60, such as a shallow groove 42 and a complimentary deep groove 41 for mounting of the mounting hardware 30.

In the embodiment shown, a first tire mount 12-1 is of a selected first width, W₁, while a second tire mount 12-2 is of a selected second width, W₂. The first width, W₁, and the second width, W₂, may be of different widths, the same width, or equivalent widths. Therefore, the first tire mount 12-1 may accommodate a first tire 11, while the second tire mount 12-2 may accommodate a second tire 11. Accordingly, the first tire 11 and the second tire 11 may be of differing qualities.

Separating the first tire mount 12-1 and the second tire mount 12-2 is a mid-section 65. The mid-section 65 is generally of a separation width, Wₛ. The separation width, Wₛ, provides for adequate separation of each tire 11 when properly mounted and inflated in the first tire mount 12-1 and the second tire mount 12-2.

Generally, an inner portion of the hub 20 includes the hub mount 13, which includes installation features 64 for installing the hub 20 onto the drive (in this case, the spindle 15 of the wheel motor 17). The hub mount 13 and installation features 64 may include, for example and without limitation, at least one flange, at least one set of bolt holes, at least one set of bolts, at least one clamp, at least one interlock and other such features. In some embodiments, the installation features 64 are accessible through the outer surface of the hub 20. As one example, a plurality of bolts may be used to secure the hub 20 to the spindle 15 from the mid-section 65, accessible via an access way 63 in the mid-section 65. This embodiment may be used in conjunction with a dished mid-section 65, such that an inner tire 11 may be easily slid over the mid-section 65 and into place on the inner tire mount 12-1.

The hub 20 may include at least one thruway between each of the tire mounts 12 and the inner surface of the hub 20. Each of the thruways (not shown) may provide for installation of pneumatic valves, such as a Schrader valve. Of course, any suitable valve system may be used.

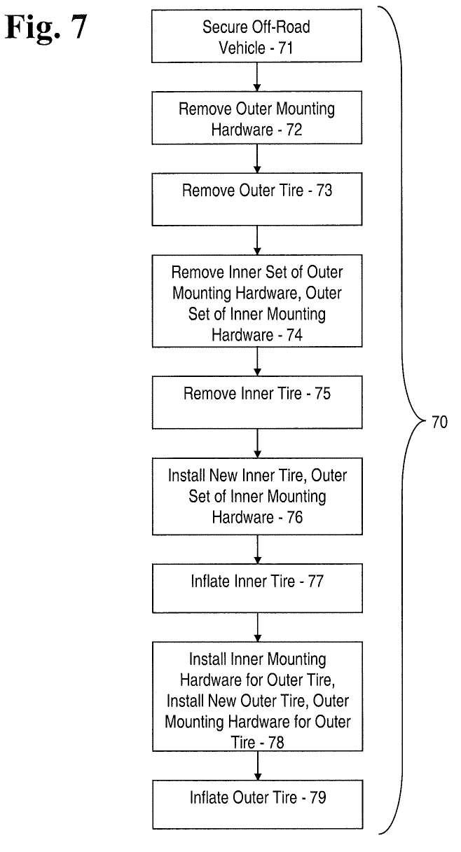

Mounting of each tire 11 may include use of lubricants and other such materials. An exemplary process for mounting a tire on the unitized hub 20 is depicted in FIG. 7.

In FIG. 7, an exemplary method for changing tires 70 is depicted. In this example, the method for changing tires 70 begins with securing the off-road vehicle 71. Securing the off-road vehicle 71 may include selecting a maintenance area, parking the off-road vehicle in the maintenance area, chocking or otherwise preventing movement of the vehicle, jacking or lifting the appropriate wheel assembly 10, and deflating or otherwise preparing the tires 11.

In a second stage 72, outer mounting hardware is removed. Once the outer mounting hardware is removed, in a third stage 73, the outer tire is removed. At this point, an inner set of mounting hardware for the outer tire is easily accessed. Accordingly, in a fourth stage 74, the inner set of mounting hardware for the outer tire is removed, as is the outer mounting hardware for the inner tire. In a fifth stage 75, the inner tire is removed. In a sixth stage 76, a new inner tire is installed by simply installing inner mounting hardware and placing the tire onto the terminal end of the hub 20 and sliding the inner tire down the length, L, of the hub 20 until the tire fits snuggly into place against the inner mounting hardware. The outer mounting hardware for the inner tire is also installed. In a seventh stage 77, the inner tire is inflated and checked for proper mounting. In an eighth stage 78, the outer tire is then mounted with appropriate mounting hardware. In a ninth stage 79, the outer tire is then inflated and checked for proper mounting. Generally, inflating each tire includes coupling an air supply to at least one valve disposed on an inner surface of the hub opposite to each of the tire mounts.

Of course, while the foregoing procedure is merely exemplary and such stages may be performed in differing order, or omitted, and other stages may be added, it should be recognized that the exemplary method is considerably less time consuming than presently achievable. Accordingly, the unitized hub 20, and the embodiments herein of a dual wheel assembly 10 that make use of the unitized hub 20 provide users with improved method and apparatus for mounting and dismounting large tires, such as those used for off-road operations. Advantageously, the solutions expedite maintenance operations. Further advantages include: elimination of rim clamps and associated fasteners which eliminates a need for wheel clamp fastener torquing; a simple design that is easy to manufacture, and therefore less expensive; a steel casting of the hub is smaller than conventional design and therefore less expensive and lighter weight for easier handling; tires can be safely mounted and dismounted by tire handling equipment, thus enhancing personnel safety; further, safety is enhanced as there are no bolts to install or remove to change a tire; and, the hub provides structural benefits of rim components that are welded to it, leading to a more efficient design.

Having thus disclosed aspects of the unitized hub, it should be recognized that any number of tires may be mounted on the unitized hub. That is, a design for the hub need not be limited to two tires. That is, three or more tires may be mounted onto appropriately designed hubs.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A hub for mounting at least one wheel of a vehicle, the hub comprising:
an annular cylinder comprising at least one tire mount disposed about a circumference of an outer surface of the cylinder, each mount comprising at least one set of mounting features for receiving mounting hardware and retaining the tire.

2. The hub as in claim 1, wherein the hub comprises two mounts, each mount for mounting a single tire.

3. The hub as in claim 1, wherein the set of mounting features comprises at least one of a shallow groove and a deep groove.

4. The hub as in claim 1, further comprising a mid-section disposed between the at least two tire mounts.

5. The hub as in claim 4, further comprising a taper in the mid-section.

6. The hub as in claim 5, wherein a tire mount outwardly disposed from the taper further comprises an elevated mount.

7. The hub as in claim 1, wherein the mid-section comprises at least one of a dished section and an installation feature adapted for installing the hub with a drive mechanism.

8. The hub as in claim 1, wherein the installation features comprise at least one of a flange, a set of bolt holes, a set of bolts, at least one clamp and at least one interlock.

9. The hub as in claim 1, wherein the mounting hardware comprises at least one of a bead band, an O-ring, a lock ring and a flange.

10. The hub as in claim 9, wherein the lock ring comprises at least one of a split lock ring and at least one retainer.

11. The hub as in claim 1, wherein the mounting hardware comprises at least one of an interlock, a bolt, a clamp and a clip.

12. A dual wheel assembly comprising:
a unitized hub comprising an annular cylinder including an inner tire mount and an outer tire mount disposed about a circumference of an outer surface of the cylinder, each of the tire mounts separated by a mid-section;
wherein the inner tire mount comprises an inner set and an outer set of mounting features, and the outer tire mount comprises an inner set and an outer set of mounting features;
each of the inner sets and outer sets adapted for receiving mounting hardware and retaining an inner sidewall and an outer sidewall of a tire.

13. The dual wheel assembly as in claim 12, further comprising at least one of the inner tire and the outer tire mounted thereon.

14. The dual wheel assembly as in claim 12, further comprising at least one thruway for inflating one of the inner tire and the outer tire.

15. The dual wheel assembly as in claim 12, further comprising installation features for mating the dual wheel assembly with a drive mechanism.

16. The dual wheel assembly as in claim 15, wherein the drive mechanism comprises one of a wheel motor and a drive shaft.

17. A vehicle comprising:
a rear axle comprising a dual wheel assembly disposed on each end thereof, each of the dual wheel assembly comprising a unitized hub comprising an annular cylinder including an inner tire mount and an outer tire mount disposed about a circumference of an outer surface of the cylinder, each of the tire mounts separated by a mid-section, wherein the inner tire mount comprises an inner set and an outer set of mounting features, and the outer tire mount comprises an inner set and an outer set of mounting features; each of the inner sets and outer sets adapted for receiving mounting hardware and retaining an inner sidewall and an outer sidewall of a tire; and
a drive mechanism for propelling each of the dual wheel assemblies.
